(19) United States
(12) Patent Application Publication
(10) Pub. No.: US 2010/0099480 A1
(43) Pub. Date: Apr. 22, 2010

(54) GAMING SYSTEM HAVING MULTIPLE HAND CARD GAME WITH POST DEAL WAGER ASSIGNMENT OPTIONS

(75) Inventor: Scott A. Caputo, Santa Clara, CA (US)

Correspondence Address: K&L Gates LLP, P.O. Box 1135, CHICAGO, IL, 60690, US

(73) Assignee: IGT, Reno, NV (US)

(21) Appl. No.: 12/255,415

(22) Filed: Oct. 21, 2008

(51) Int. Cl. A63F 9/24; A63F 13/00

(52) U.S. Cl. 463/12

(57) ABSTRACT

A gaming system and method providing a multiple hand Blackjack game is provided. The gaming system and method enables the player to place three separate wagers. The gaming system and method causes two player hands to be dealt to the player and also causes the cards in the first player hand to be revealed to the player. A first one of the three wagers is assigned to the first player hand and a second one of the three wagers is assigned to the second player hand. The third wager is not initially assigned to either of the player hands. After viewing only the cards in the first player hand, the player has the option to assign the third wager to either the first or second player hands. After the player has assigned the third wager, the gaming system reveals the cards in the second player hand and enables the player to draw, hit, double-down, or split cards in each of the player hands according to standard Blackjack rules. An outcome of the game is determined based on final player hands and dealer hand, and the gaming system determines winning hands.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Blackjack is a very well known and popular card game. Gaming establishments are always introducing variations to slot machines and card games to increase player excitement and enjoyment. One method of increasing player excitement is to include additional wagering opportunities, bonus games or payout schemes. Numerous methods have been considered for increasing the amounts wagered by players on each hand or round of play in Blackjack and other card games.

U.S. Patent Publication No. 2008/0012224 describes a Blackjack game that is played by one or more players, each player placing three separate wagers on a single round of play of the game. For each player, a first of the three wagers is committed to a first hand wagering position, a second wager is committed to a second hand wagering position, and a third wager is not initially committed to either of the first or second wagering positions. From a first set of playing cards, each player receives initial separate hands, one initial hand at each of the first hand wagering position and one initial hand at the second hand wagering position. Each player, after viewing each of the cards in that player's initial first hand and the cards in that player's initial second hand, commits their third wager to either the first hand wagering position or the second hand wagering position. Each player has an advantage by being able to postpone assigning their third wager until after the player sees the initial cards of each of their hands and thus can assign the wager to the better initial or starting hand.

To maintain a house advantage over the player (i.e., to offset this player advantage), U.S. Patent Publication No. 2008/0012224 teaches that the third wager is forfeited under certain circumstances. More specifically, U.S. Patent Publication No. 2008/0012224 requires or relies on complicated card color and/or card suit rules to determine forfeiture or loss of the third wager. For example, if a player receives four cards of the same color, the player's third wager (which is sometimes called a “press” bet) is forfeited or lost to the house. In other versions of the game, U.S. Patent Publication No. 2008/0012224 requires that if the player receives four cards of the same suit (in the two initial player hands), all three of the player's bets are forfeited or lost to the house. Accordingly, there is a significant problem with the various embodiments of the game disclosed in U.S. Patent Publication No. 2008/0012224 because a player has to forfeit wagers under certain circumstances for the house to maintain the required mathematically expected advantage of the house over the player. Additionally, the need to determine color combinations of the player initial cards in the hands can be a distraction from the Blackjack primary game (in part because determining color combinations are not a normal part of Blackjack games). Therefore, there is a need to create a new and exciting Blackjack game that eliminates these significant disadvantages.

### SUMMARY

Various embodiments of the present disclosure relate to a gaming system for providing a Blackjack game, and methods of playing and operating a Blackjack game at a gaming table or through a gaming device. The present disclosure also relates to a multiple hand card game, and the use of modified wagering opportunities and rules therein. In an embodiment, a gaming system provides a multiple hand Blackjack or Twenty-One card game where the player is able to choose whether to assign a pre-committed wager (such as a press or extra wager) amount to one of several different player hands without a risk that the pre-committed wager will be forfeited. That is, the pre-committed press wager may be lost if the player hand (to which the wager is assigned) eventually loses to the dealer hand, but it will not be forfeited such as based on the color of the cards in the player hand, the suit of the cards in the player hand, the combination of player cards, or any other forfeiture criteria. In one embodiment, the gaming system enables the player to assign this press wager after viewing the identity of the cards in a first one of the player hands. This gives the player an advantage of knowing the strength of one of the starting player hands prior to committing the press wager to one of the different player hands. This advantage to the player is offset by one or more modifications to standard Blackjack rules. For example, in one embodiment, the payout ratio on a natural Blackjack is altered to be lower than the standard payout ratio. Any other suitable method of adjusting the mathematically expected advantage to be in favor of the house can be such that the player does not risk forfeiture of the pre-committed press wager, as discussed above. Although Blackjack is used in several examples described below, it should be appreciated that the embodiments are not limited to Blackjack, and may include other suitable video or non-video (i.e., live) based cards games.

More specifically, in one embodiment, a gaming system providing the multiple hand Blackjack game enables a player to place a designated number of wagers such as three separate wagers. A first one of the wagers is applied to a first player hand, and a second one of the wagers is applied to a second player hand. The third wager, called a press wager, is not initially linked or assigned to either of the two player hands. The gaming system or method causes cards to be dealt to form the starting first and second player hands. Only the cards in one of player hands (i.e., but not the other one) are initially revealed to the player. Based on only the knowledge of the cards in the first player hand, the player must assign the third or press wager either to the first player hand (where the values of the cards are known) or to the second player hand (where the values of the cards are unknown). After the third or press wager has been assigned to one of the player hands, the gaming system causes the cards in the second player hand to be revealed to the player. The remainder of the Blackjack is played out as in a traditional game of Blackjack.

In one alternative, the player must assign the third or press wager to one of the player hands before the dealer's up-card is revealed. In another alternative, the player must assign the third or press wager to player hand after the dealer's up-card is revealed.

It should be appreciated that this advantage to the player is minimized because the player does not know the initial or starting cards in the second hand. It should also be appreciated that the paytable may be suitably changed to adjust for the players advantage. It should also be appreciated that the number of wagers and the number of hands may vary as long as there are at least two hands and the number of wagers is greater than the number of hands.

Additional features and advantages are described herein, and will be apparent from, the following Detailed Description and the figures.

### BRIEF DESCRIPTION OF THE FIGURES

FIG. 1A is a front perspective view of one embodiment of the gaming system of the present disclosure.

FIG. 1B is a front perspective view of one embodiment, of the gaming system of the present disclosure.

FIG. 1C is a front perspective view of another embodiment of the gaming system of the present invention.

FIG. 1D is a top view of the gaming system of FIG. 1C.

FIG. 1E is an enlarged fragmentary top view of a section of the gaming table illustrated in FIG. 1D.

FIG. 2A is a schematic diagram of the electronic configuration of one embodiment of the gaming device of the present disclosure.

FIG. 2B is a schematic diagram of the data network that one or more of the gaming devices of the present disclosure may be connected to.

FIGS. 3A, 3B, 3C, 3D and 3E are flow diagrams of the card game, in one embodiment.

FIGS. 4A, 4B, 4C and 4D are illustrations of screen displays for a round of play of the game, of one embodiment.

### DETAILED DESCRIPTION

The present disclosure can be implemented at a suitable gaming table (such as a felt-top table) and/or through a gaming system or gaming device. The present disclosure may be implemented in various configurations for gaming machines, gaming devices or gaming systems, including but not limited to: (1) a dedicated gaming machine, gaming device, or gaming systems wherein the computerized instructions for controlling any games (which are provided by the gaming machine or gaming device) are provided with the gaming machine or gaming device prior to delivery to a gaming establishment; and (2) a changeable gaming machine, gaming device, or gaming system wherein the computerized instructions for controlling any games (which are provided by the gaming machine or gaming device) are downloadable to the gaming machine or gaming device through a data network after the gaming machine or gaming device is in a gaming establishment. In one embodiment, the computerized instructions for controlling any games are executed by at least one central server, central controller, or remote host. In such a “thin client” embodiment, the central server remotely controls any games (or other suitable interfaces) and the gaming device is utilized to display such games (or suitable interfaces) and receive one or more inputs or commands from a player. In another embodiment, the computerized instructions for controlling any games are communicated from the central server, central controller, or remote host to a gaming device local processor and memory devices. In such a “thick client” embodiment, the gaming device local processor executes the communicated computerized instructions to control any games (or other suitable interfaces) provided to a player.

In one embodiment, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

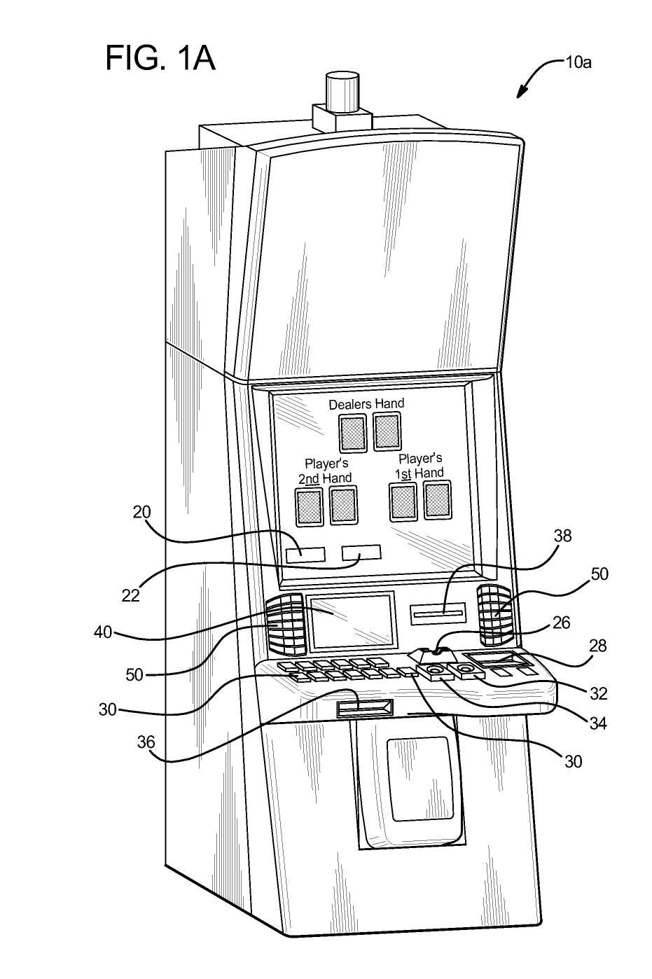

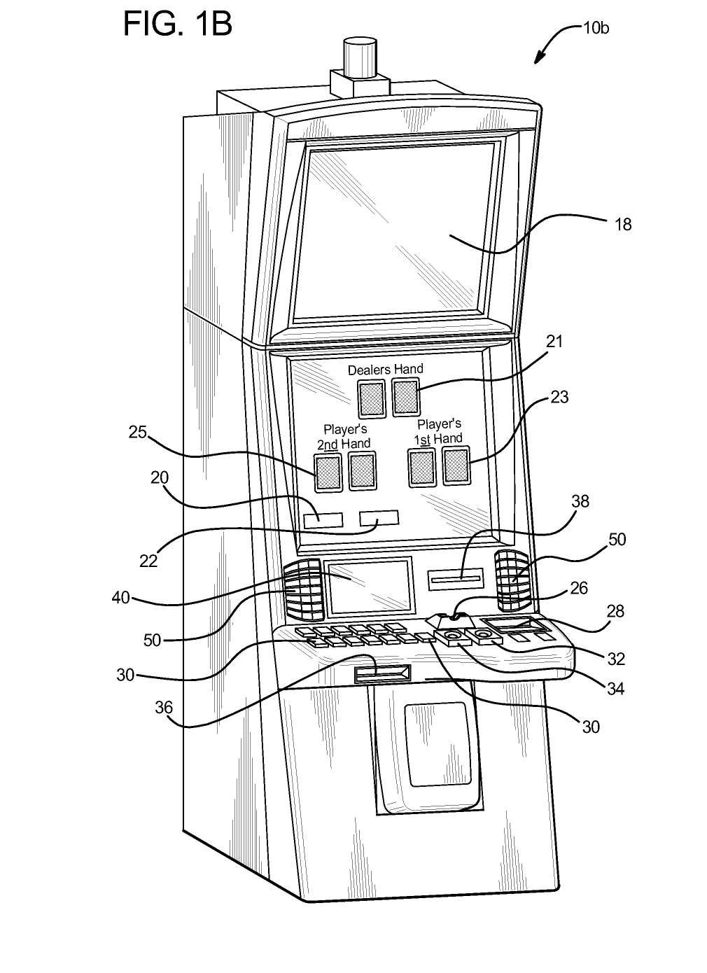

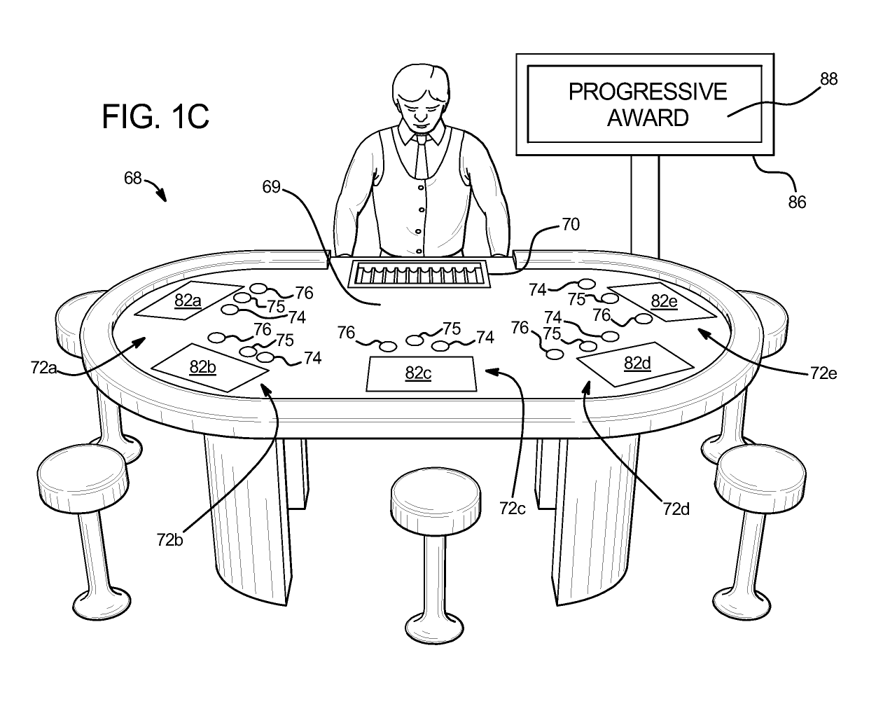

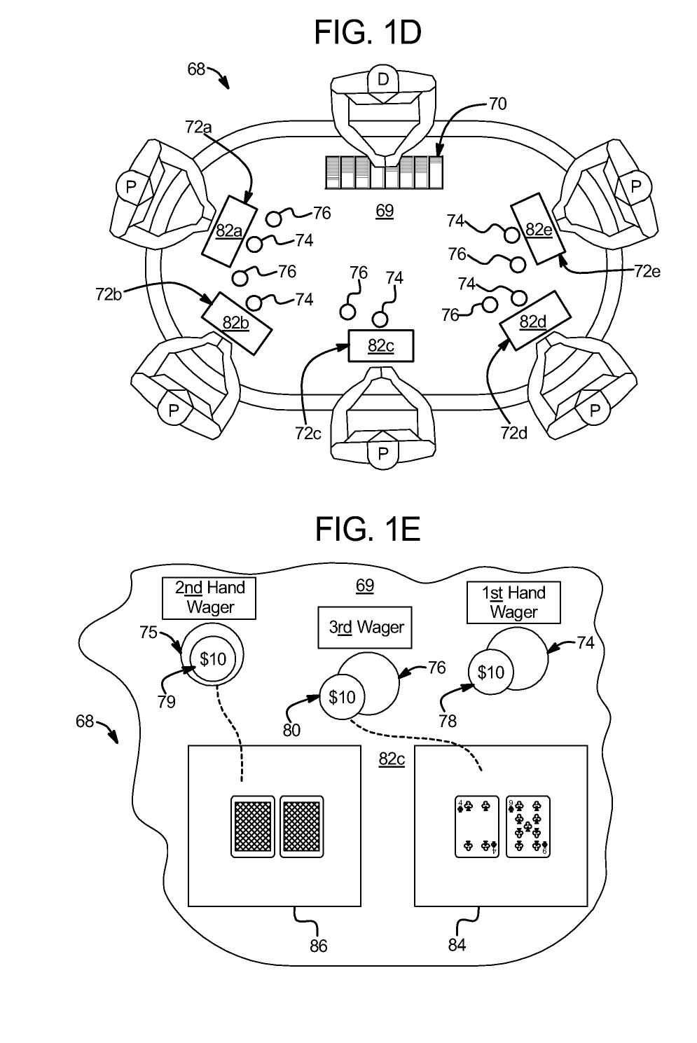

Referring now to the drawings, two example alternative embodiments of a gaming device disclosed herein are illustrated in FIGS. 1A and 1B as gaming device 10a and gaming device 10b, respectively. Gaming device 10a and/or gaming device 10b are generally referred to herein as gaming device 10. In another embodiment, as shown in FIGS. 1C, 1D, and 1E, the gaming device can be a live gaming table such as a Blackjack table.

It should be appreciated that the present disclosure can be implemented through an automated or semi-automated gaming table where one or more of the functions of dealing and displaying cards, tracking the cards, handling chips or other wagers, tracking chips or other wagers, and providing payouts or tracking payouts to players are performed electrically or with suitable tracking devices.

It should also be appreciated that the present disclosure can be implemented in a single player configuration or in a multiple player configuration.

In the embodiments illustrated in FIGS. 1A and 1B, gaming device 10 has a support structure, housing, or cabinet which provides support for a plurality of displays, inputs, controls, and other features of a conventional gaming machine. It is configured so that a player can operate it while standing or sitting. The gaming device can be positioned on a base or stand or can be configured as a video game with horizontally aligned or nearly horizontally aligned video display step within a flat surface, often referred to as a “bar-top” or “slant-top” game (not shown) which a player can operate preferably while sitting. As illustrated by the different configurations shown in FIGS. 1A and 1B, the gaming device may have varying cabinet and display configurations.

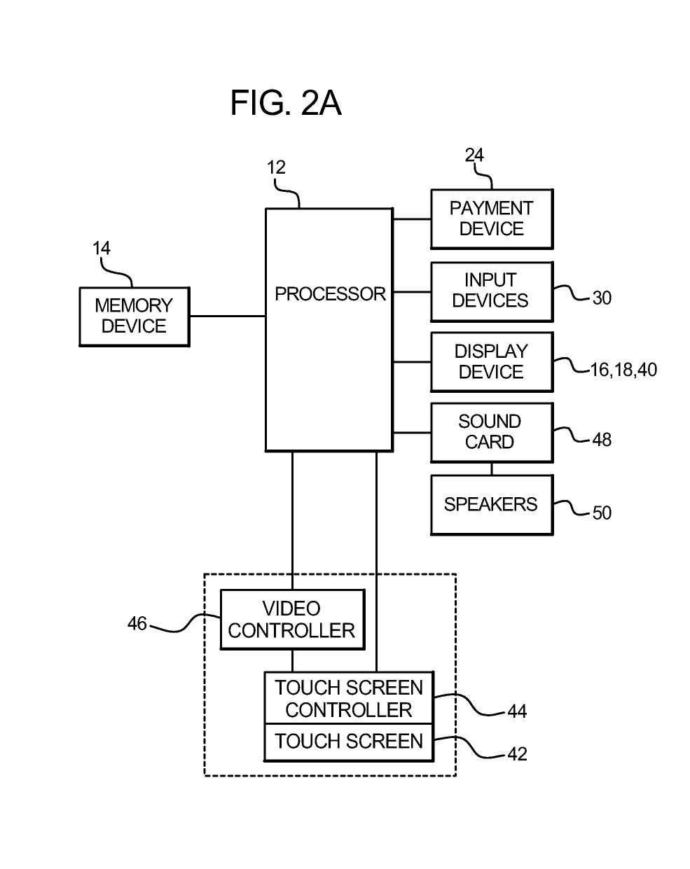

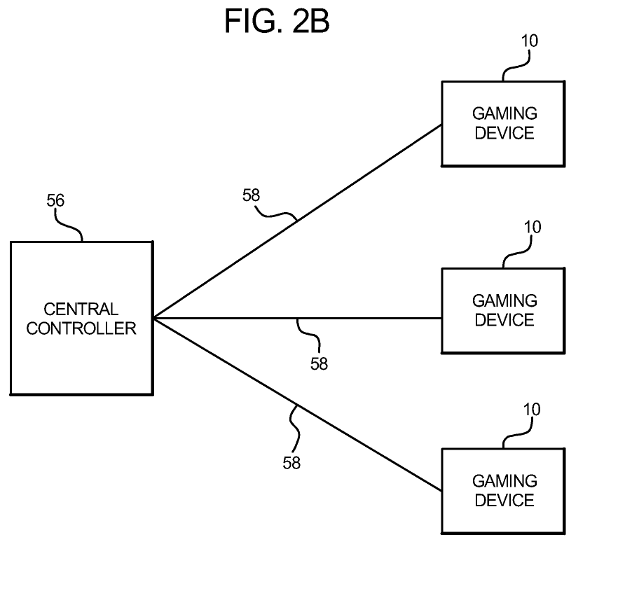

In one embodiment, as illustrated in FIG. 2A, the gaming device preferably includes at least one processor 12, such as a microprocessor, a microcontroller-based platform, a suitable integrated circuit or one or more application-specific integrated circuits (ASIC's). The processor is in communication with or operable to access or to exchange signals with at least one data storage or memory device 14. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information, and applicable game rules that relate to the play of the gaming device. In one embodiment, the memory device includes random access memory (RAM), which can include non-volatile RAM (NVRAM), magnetic RAM (MRAM), ferroelectric RAM (FeRAM), and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical, and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD, or USB memory device. In other embodiments, part or all of the program code and/or operating data described above can be downloaded to the memory device through a suitable network.

In one embodiment, an operator or a player can use such a removable memory device in a desktop computer, a laptop computer, a personal digital assistant (PDA), a portable computing device, or another computerized platform to implement the present disclosure. In one embodiment, the gaming device or gaming machine disclosed herein is operable over a wireless network, for example part of a wireless gaming system. In this embodiment, the gaming machine may be a hand-held device, a mobile device, or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “computer” or “controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator, or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome.

In another embodiment, as discussed in more detail below, the gaming device employs a predetermined or finite set or pool of awards or other game outcomes. In this embodiment, as each award or other game outcome is provided to the player, the gaming device flags or removes the provided award or other game outcome from the predetermined set or pool. Once flagged or removed from the set or pool, the specific provided award or other game outcome from that specific pool cannot be provided to the player again. This type of gaming device provides players with all of the available awards or other game outcomes over the course of the play cycle and guarantees the amount of actual wins and losses.

In one embodiment, as illustrated in FIG. 2A, the gaming device includes one or more display devices controlled by the processor. The display devices are preferably connected to or mounted on the cabinet of the gaming device. The embodiment shown in FIG. 1A includes a central display device 16 which displays a primary game. This display device may also display any suitable secondary game associated with the primary game as well as information relating to the primary or secondary game. The alternative embodiment shown in FIG. 1B includes a central display device 16 and an upper display device 18. The upper display device may display the primary game, any suitable secondary game associated or not associated with the primary game and/or information relating to the primary or secondary game. These display devices may also serve as digital glass operable to advertise games or other aspects of the gaming establishment. As seen in FIGS. 1A and 1B, in one embodiment, the gaming device includes a credit display 20 which displays a player's current number of credits, cash, account balance, or the equivalent. In one embodiment, the gaming device includes a bet display 22 which displays a player's amount wagered. In one embodiment, as described in more detail below, the gaming device includes a player tracking display 40 which displays information regarding a player's play tracking status.

In another embodiment, at least one display device may be a mobile display device, such as a PDA or tablet PC, that enables play of at least a portion of the primary or secondary game at a location remote from the gaming device.

The display devices may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In one embodiment, as described in more detail below, the display device includes a touch-screen with an associated touch-screen controller. The display devices may be of any suitable size and configuration, such as a square, a rectangle or an elongated rectangle.

The display devices of the gaming device are configured to display at least one and preferably a plurality of game or other suitable images, symbols and indicia such as any visual representation or exhibition of the movement of objects such as mechanical, virtual, or video reels and wheels, dynamic lighting, video images, images of people, characters, places, things, faces of cards, and the like.

As illustrated in FIG. 2A, in one embodiment, the gaming device includes at least one payment device 24 in communication with the processor. As seen in FIGS. 1A and 1B, a payment device such as a payment acceptor includes a note, ticket or bill acceptor 28 wherein the player inserts paper money, a ticket, or voucher and a coin slot 26 where the player inserts money, coins, or tokens. In other embodiments, payment devices such as readers or validators for credit cards, debit cards or credit slips may accept payment. In one embodiment, a player may insert an identification card into a card reader of the gaming device. In one embodiment, the identification card is a smart card having a programmed microchip or a magnetic strip coded with a player's identification, credit totals (or related data), and other relevant information. In another embodiment, a player may carry a portable device, such as a cell phone, a radio frequency identification tag, or any other suitable wireless device, which communicates a player's identification, credit totals (or related data), and other relevant information to the gaming device. In one embodiment, money may be transferred to a gaming device through electronic funds transfer. When a player funds the gaming device, the processor determines the amount of funds entered and displays the corresponding amount on the credit or other suitable display as described above.

As seen in FIGS. 1A, 1B, and 2A, in one embodiment the gaming device includes at least one and preferably a plurality of input devices 30 in communication with the processor. The input devices can include any suitable device which enables the player to produce an input signal which is received by the processor. In one embodiment, after appropriate funding of the gaming device, the input device is a game activation device, such as a play button 32 or a pull arm (not shown) which is used by the player to start any primary game or sequence of events in the gaming device. The play button can be any suitable play activator such as a bet one button, a max bet button, or a repeat the bet button. In one embodiment, upon appropriate funding, the gaming device begins the game play automatically. In another embodiment, upon the player engaging one of the play buttons, the gaming device automatically activates game play.

In one embodiment, one input device is a bet one button. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one. In another embodiment, one input device is a bet max button (not shown) which enables the player to bet the maximum wager permitted for a game of the gaming device.

In one embodiment, one input device is a cash out button 34. The player may push the cash out button and cash out to receive a cash payment or other suitable form of payment corresponding to the number of remaining credits. In one embodiment, when the player cashes out, a payment device, such as a ticket, payment, or note generator 36 prints or otherwise generates a ticket or credit slip to provide to the player. The player receives the ticket or credit slip and may redeem the value associated with the ticket or credit slip via a cashier (or other suitable redemption system). In another embodiment, when the player cashes out, the player receives the coins or tokens in a coin payout tray. It should be appreciated that any suitable payout mechanisms, such as funding to the player's electronically recordable identification card, may be implemented in accordance with the gaming device disclosed herein.

In one embodiment, as mentioned above and as seen in FIG. 2A, one input device is a touch-screen 42 coupled with a touch-screen controller 44 or some other touch-sensitive display overlay to allow for player interaction with the images on the display. The touch-screen and the touch-screen controller are connected to a video controller 46. A player can make decisions and input signals into the gaming device by touching the touch-screen at the appropriate locations. One such input device is a conventional touch-screen button panel.

The gaming device may further include a plurality of communication ports for enabling communication of the processor with external peripherals, such as external video sources, expansion buses, game or other displays, a SCSI port, or a keypad.

In one embodiment, as seen in FIG. 2A, the gaming device includes a sound generating device controlled by one or more sounds cards 48 which function in conjunction with the processor. In one embodiment, the sound generating device includes at least one and preferably a plurality of speakers 50 or other sound generating hardware and/or software for generating sounds, such as by playing music for the primary and/or secondary game or by playing music for other modes of the gaming device, such as an attract mode. In one embodiment, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized to provide any appropriate information.

In one embodiment, the gaming machine may include a sensor, such as a camera in communication with the processor (and possibly controlled by the processor), that is selectively positioned to acquire an image of a player actively using the gaming device and/or the surrounding area of the gaming device. In one embodiment, the camera may be configured to selectively acquire still or moving (e.g., video) images and may be configured to acquire the images in an analog, digital, or other suitable format. The display devices may be configured to display the image acquired by the camera as well as to display the visible manifestation of the game in split screen or picture-in-picture fashion. For example, the camera may acquire an image of the player and the processor may incorporate that image into the primary and/or secondary game as a game image, symbol or indicia.

Gaming device 10 can incorporate any suitable wagering game as the primary or base game. The gaming machine or device may include some or all of the features of conventional gaming machines or devices. The primary or base game may comprise any suitable reel-type game, card game, cascading or falling symbol game. number game, or other game of chance susceptible to representation in an electronic or electromechanical form, which in one embodiment produces a random outcome based on probability data at the time of or after placement of a wager. That is, different primary wagering games, such as video poker games, video Blackjack games, video keno, video bingo or any other suitable primary or base game may be implemented.

In one embodiment, a base or primary game is a multiple hand Blackjack game wherein the gaming system or device enables the player to play a multiple hand game of Blackjack with conventional Blackjack rules. The gaming system initially deals two two-card player hands from a virtual deck of fifty-two cards. As described in further detail below, the cards in the first player hand are dealt face-up and the cards in the second player hand are dealt face-down. Cards may be dealt as in a traditional game of cards or in the case of the gaming device, the cards may be randomly selected from a predetermined number of cards. In an embodiment, after the player views the cards in the first player hand, the player assigns a wager to either of the first and second player hands based on which hand the player expects will have the best outcome. After assigning the third wager, the gaming system reveals the card in the second player hand and reveals one of the cards in the dealer hand. At this point, the player can hit, split, draw cards, double-down, take insurance according to the rules of the game. The player selects the options via one or more input devices, such as by pressing related buttons or via the touch screen. The gaming device compares the final player hands to the final dealer hand to determine the winning hands. The gaming device provides the player with an award based on a winning hand and the number of credits the player wagered.

In one embodiment, in addition to winning credits or other awards in a base or primary game, the gaming device may also give players the opportunity to win credits in a bonus or secondary game or in a bonus or secondary round. The bonus or secondary game enables the player to obtain a prize or payout in addition to the prize or payout, if any, obtained from the base or primary game. In general, a bonus or secondary game produces a significantly higher level of player excitement than the base or primary game because it provides a greater expectation of winning than the base or primary game, and is accompanied with more attractive or unusual features than the base or primary game. In one embodiment, the bonus or secondary game may be any type of suitable game, either similar to or completely different from the base or primary game.

In one embodiment, the triggering event or qualifying condition may be a selected outcome in the primary game or a particular arrangement of one or more indicia on a display device in the primary game, such as the card values appearing in the player or dealer hands in the primary Blackjack game embodiment seen in FIGS. 1A and 1B. In other embodiments, the triggering event or qualifying condition occurs based on exceeding a certain amount of game play (such as number of games, number of credits, amount of time), or reaching a specified number of points earned during game play.

In another embodiment, the gaming device processor 12 or central server 56 randomly provides the player one or more plays of one or more secondary games. In one such embodiment, the gaming device does not provide any apparent reason to the player for qualifying to play a secondary or bonus game. In this embodiment, qualifying for a bonus game is not triggered by an event in or based specifically on any of the plays of any primary game. That is, the gaming device may simply qualify a player to play a secondary game without any explanation or alternatively with simple explanations. In another embodiment, the gaming device (or central server) qualifies a player for a secondary game at least partially based on a game triggered or symbol triggered event, such as at least partially based on the play of a primary game.

In one embodiment, the gaming device includes a program which will automatically begin a bonus round after the player has achieved a triggering event or qualifying condition in the base or primary game. In another embodiment, after a player has qualified for a bonus game, the player may subsequently enhance his/her bonus game participation through continued play on the base or primary game. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple such bonus qualifying events in the primary game may result in an arithmetic or exponential increase in the number of bonus wagering credits awarded. In one embodiment, the player may redeem extra bonus wagering credits during the bonus game to extend play of the bonus game.

In one embodiment, no separate entry fee or buy-in for a bonus game is needed. That is, a player may not purchase entry into a bonus game; rather they must win or earn entry through play of the primary game, thus encouraging play of the primary game. In another embodiment, qualification of the bonus or secondary game is accomplished through a simple “buy-in” by the player—for example, if the player has been unsuccessful at qualifying through other specified activities. In another embodiment, the player must make a separate side-wager on the bonus game or wager a designated amount in the primary game to qualify for the secondary game. In this embodiment, the secondary game triggering event must occur and the side-wager (or designated primary game wager amount) must have been placed to trigger the secondary game.

In one embodiment, as illustrated in FIG. 2B, one or more of the gaming devices 10 are in communication with each other and/or at least one central server, central controller or remote host 56 through a data network or remote communication link 58. In this embodiment, the central server, central controller or remote host is any suitable server or computing device which includes at least one processor and at least one memory or storage device. In different such embodiments, the central server is a progressive controller or a processor of one of the gaming devices in the gaming system. In these embodiments, the processor of each gaming device is designed to transmit and receive events, messages, commands, or any other suitable data or signal between the individual gaming device and the central server. The gaming device processor is operable to execute such communicated events, messages, or commands in conjunction with the operation of the gaming device. Moreover, the processor of the central server is designed to transmit and receive events, messages, commands, or any other suitable data or signal between the central server and each of the individual gaming devices. The central server processor is operable to execute such communicated events, messages, or commands in conjunction with the operation of the central server. It should be appreciated that one, more or each of the functions of the central controller as disclosed herein may be performed by one or more gaming device processors. It should be further appreciated that one, more or each of the functions of one or more gaming device processors as disclosed herein may be performed by the central controller.

In one embodiment, the game outcome provided to the player is determined by a central server or controller and provided to the player at the gaming device. In this embodiment, each of a plurality of such gaming devices are in communication with the central server or controller. Upon a player initiating game play at one of the gaming devices, the initiated gaming device communicates a game outcome request to the central server or controller.

In one embodiment, the central server or controller receives the game outcome request and randomly generates a game outcome for the primary game based on probability data. In another embodiment, the central server or controller randomly generates a game outcome for the secondary game based on probability data. In another embodiment, the central server or controller randomly generates a game outcome for both the primary game and the secondary game based on probability data. In this embodiment, the central server or controller is capable of storing and utilizing program code or other data similar to the processor and memory device of the gaming device.

In an alternative embodiment, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such as free games.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility, and the like.

In another embodiment, one or more of the gaming devices are in communication with a central server or controller for monitoring purposes only. That is, each individual gaming device randomly generates the game outcomes to be provided to the player and the central server or controller monitors the activities and events occurring on the plurality of gaming devices. In one embodiment, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

In one embodiment, the gaming device disclosed herein is associated with or otherwise integrated with one or more player tracking systems. Player tracking systems enable gaming establishments to recognize the value of customer loyalty through identifying frequent customers and rewarding them for their patronage. In one embodiment, the gaming device and/or player tracking system tracks any player's gaming activity at the gaming device. In one such embodiment, the gaming device includes at least one card reader 38 in communication with the processor. In this embodiment, a player is issued a player identification card which has an encoded player identification number that uniquely identifies the player. When a player inserts their playing tracking card into the card reader to begin a gaming session, the card reader reads the player identification number off the player tracking card to identify the player. The gaming device and/or associated player tracking system timely tracks any suitable information or data relating to the identified player's gaming session. Directly or via the central controller, the gaming device processor communicates such information to the player tracking system. The gaming device and/or associated player tracking system also timely tracks when a player removes their player tracking card when concluding play for that gaming session. In another embodiment, rather than requiring a player to insert a player tracking card, the gaming device utilizes one or more portable devices carried by a player, such as a cell phone, a radio frequency identification tag or any other suitable wireless device to track when a player begins and ends a gaming session. In another embodiment, the gaming device utilizes any suitable biometric technology or ticket technology to track when a player begins and ends a gaming session.

During one or more gaming sessions, the gaming device and/or player tracking system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In one embodiment, such tracked information and/or any suitable feature associated with the player tracking system is displayed on a player tracking display 40. In another embodiment, such tracked information and/or any suitable feature associated with the player tracking system is displayed via one or more service windows (not shown) which are displayed on the central display device and/or the upper display device.

In one embodiment, a plurality of the gaming devices are capable of being connected together through a data network. In one embodiment, the data network is a local area network (LAN), in which one or more of the gaming devices are substantially proximate to each other and an on-site central server or controller as in, for example, a gaming establishment or a portion of a gaming establishment. In another embodiment, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system may be substantially identical to the LAN gaming system described above, although the number of gaming devices in each system may vary relative to one another.

In another embodiment, the data network is an internet or intranet. In this embodiment, the operation of the gaming device can be viewed at the gaming device with at least one internet browser. In this embodiment, operation of the gaming device and accumulation of credits may be accomplished with only a connection to the central server or controller (the internet/intranet server) through a conventional phone or other data transmission line, digital subscriber line (DSL), T-1 line, coaxial cable, fiber optic cable, or other suitable connection. In this embodiment, players may access an internet game page from any location where an internet connection and computer or other internet facilitator is available. The expansion in the number of computers and number and speed of internet connections in recent years increases opportunities for players to play from an ever-increasing number of remote sites. It should be appreciated that the enhanced bandwidth of digital wireless communications may render such technology suitable for some or all communications, particularly if such communications are encrypted. Higher data transmission speeds may be useful for enhancing the sophistication and response of the display and interaction with the player.

As mentioned above, in one embodiment, the present disclosure may be employed in a server-based gaming system. In one such embodiment, as described above, one or more gaming devices are in communication with a central server or controller. The central server or controller may be any suitable server or computing device which includes at least one processor and a memory or storage device. In alternative embodiments, the central server is a progressive controller or another gaming machine in the gaming system. In one embodiment, the memory device of the central server stores different game programs and instructions, executable by a gaming device processor, to control the gaming device. Each executable game program represents a different game or type of game which may be played on one or more of the gaming devices in the gaming system. Such different games may include the same or substantially the same game play with different pay tables. In different embodiments, the executable game program is for a primary game, a secondary game or both. In another embodiment, the game program may be executable as a secondary game to be played simultaneous with the play of a primary game (which may be downloaded to or fixed on the gaming device) or vice versa.

In this embodiment, each gaming device at least includes one or more display devices and/or one or more input devices for interaction with a player. A local processor, such as the above-described gaming device processor or a processor of a local server, is operable with the display device(s) and/or the input device(s) of one or more of the gaming devices.

In operation, the central controller is operable to communicate one or more of the stored game programs to at least one local processor. In different embodiments, the stored game programs are communicated or delivered by embedding the communicated game program in a device or a component (e.g., a microchip to be inserted in a gaming device), writing the game program on a disc or other media, or downloading or streaming the game program over a dedicated data network, internet, or a telephone line. After the stored game programs are communicated from the central server, the local processor executes the communicated program to facilitate play of the communicated program by a player through the display device(s) and/or input device(s) of the gaming device. That is, when a game program is communicated to a local processor, the local processor changes the game or type of game played at the gaming device.

In another embodiment, a plurality of gaming devices at one or more gaming sites may be networked to the central server in a progressive configuration, as known in the art, wherein a portion of each wager to initiate a base or primary game may be allocated to one or more progressive awards. In one embodiment, a progressive gaming system host site computer is coupled to a plurality of the central servers at a variety of mutually remote gaming sites for providing a multi-site linked progressive automated gaming system. In one embodiment, a progressive gaming system host site computer may serve gaming devices distributed throughout a number of properties at different geographical locations including, for example, different locations within a city or different cities within a state.

In one embodiment, the progressive gaming system host site computer is maintained for the overall operation and control of the progressive gaming system. In this embodiment, a progressive gaming system host site computer oversees the entire progressive gaming system and is the master for computing all progressive jackpots. All participating gaming sites report to, and receive information from, the progressive gaming system host site computer. Each central server computer is responsible for all data communication between the gaming device hardware and software and the progressive gaming system host site computer. In one embodiment, an individual gaming machine may trigger a progressive award win. In another embodiment, a central server (or the progressive gaming system host site computer) determines when a progressive award win is triggered. In another embodiment, an individual gaming machine and a central controller (or progressive gaming system host site computer) work in conjunction with each other to determine when a progressive win is triggered, for example through an individual gaming machine meeting a predetermined requirement established by the central controller.

In one embodiment, a progressive award win is triggered based on one or more game play events, such as a symbol-driven trigger. In other embodiments, the progressive award triggering event or qualifying condition may be achieved by exceeding a certain amount of game play (such as number of games, number of credits, or amount of time), or reaching a specified number of points earned during game play. In another embodiment, a gaming device is randomly or apparently randomly selected to provide a player of that gaming device one or more progressive awards. In one such embodiment, the gaming device does not provide any apparent reasons to the player for winning a progressive award, wherein winning the progressive award is not triggered by an event in or based specifically on any of the plays of any primary game. That is, a player is provided a progressive award without any explanation or alternatively with simple explanations. In another embodiment, a player is provided a progressive award at least partially based on a game triggered or symbol triggered event, such as at least partially based on the play of a primary game.

In one embodiment, one or more of the progressive awards are each funded via a side bet or side wager. In this embodiment, a player must place or wager a side bet to be eligible to win the progressive award associated with the side bet. In one embodiment, the player must place the maximum bet and the side bet to be eligible to win one of the progressive awards. In another embodiment, if the player places or wagers the required side bet, the player may wager at any credit amount during the primary game (i.e., the player need not place the maximum bet and the side bet to be eligible to win one of the progressive awards). In one such embodiment, the greater the player's wager (in addition to the placed side bet), the greater the odds or probability that the player will win one of the progressive awards. It should be appreciated that one or more of the progressive awards may each be funded, at least in part, based on the wagers placed on the primary games of the gaming machines in the gaming system, via a gaming establishment or via any suitable manner.

In another embodiment, one or more of the progressive awards are partially funded via a side-bet or side-wager which the player may make (and which may be tracked via a side-bet meter). In one embodiment, one or more of the progressive awards are funded with only side-bets or side-wagers placed. In another embodiment, one or more of the progressive awards are funded based on player's wagers as described above as well as any side-bets or side-wagers placed.

In one alternative embodiment, a minimum wager level is required for a gaming device to qualify to be selected to obtain one of the progressive awards. In one embodiment, this minimum wager level is the maximum wager level for the primary game in the gaming machine. In another embodiment, no minimum wager level is required for a gaming machine to qualify to be selected to obtain one of the progressive awards.

In another embodiment, a plurality of players at a plurality of linked gaming devices in a gaming system participate in a group gaming environment. In one embodiment, a plurality of players at a plurality of linked gaming devices work in conjunction with one another, such as by playing together as a team or group, to win one or more awards. In one such embodiment, any award won by the group is shared, either equally or based on any suitable criteria, amongst the different players of the group. In another embodiment, a plurality of players at a plurality of linked gaming devices compete against one another for one or more awards. In one such embodiment, a plurality of players at a plurality of linked gaming devices participate in a gaming tournament for one or more awards. In another embodiment, a plurality of players at a plurality of linked gaming devices play for one or more awards wherein an outcome generated by one gaming device affects the outcomes generated by one or more linked gaming devices.

### Multiple Hand Blackjack Game Embodiments

The present disclosure can be provided in a completely live setting at a gaming table using physical cards, physical chips and a live dealer. In other embodiments, the gaming table can have virtual cards and/or virtual chips and/or a virtual dealer. It should also be appreciated that the present disclosure can be provided at an individual gaming system or device for one or more players. It should also be appreciated that the present disclosure can be provided through a data network such as the internet.

In one embodiment, the gaming system, gaming device or method provides a multiple hand Blackjack game and enables a player to place three separate wagers, where one wager is assigned to a first player hand and a second wager is assigned to a second player hand. The third wager is not initially committed to any of the player hands. Based on the values of the cards revealed in the first player hand, a player may choose to assign the third wager to either the first or second player hands depending on different game play strategies. For example, if the combination of cards in the first player starting hand are close to twenty-one (e.g., eighteen, nineteen, twenty or twenty-one) the player may choose to increase the overall wager on the first player hand by assigning the third wager to this hand. However, if the combination of cards in the first player starting hand form a hand more likely to lose, such as a hand with a total between 12 and 16 inclusively, the player may choose to assign the third wager to the second player starting hand even though the cards in that starting hand are not yet dealt or are dealt face-down and not yet revealed to the player. In this embodiment, because the values of the cards in the second player hand are not known to the player, the player must make a prediction as to whether the player believes the cards in the second player hand will be better than the cards in the first player hand.

In one embodiment, as seen in FIGS. 1C, 1D, and 1E, the primary game may be a conventional game of Blackjack or twenty-one played at a live gaming table 68, on a playing surface 69, with a human dealer. The gaming table generally includes a chip tray 70 for holding several stacks of the dealer's chips. The dealer uses chips from the chip tray 70 to pay out winning hands or collect chips from players when they have lost. For each of a plurality of playing areas 72a to 72e, there are three game wagering areas 74, 75, and 76 (best seen in FIG. 1E). In one embodiment, as part of the initiation of the round of Blackjack, each player places the three wagers substantially within the game wagering areas 74, 75, and 76. In an embodiment, as seen in FIG. 1E, the three wagers 78, 79, and 80 must be of equal amounts. However, in other embodiments, the wagers may be of different amounts. As seen in FIG. 1C, the gaming table includes a plurality of display devices 82a to 82e, one for each of the players. In one embodiment, the display devices are used for displaying information related to electronically tracked playing cards in the first and second player hands. In a further embodiment, the gaming table 68 may include another display device 86 that displays a progressive award 88. The progressive award 88 may be determined by the play of just one particular round of Blackjack, it may be determined by several rounds of Blackjack, or it may be determined by contributions from different gaming tables 68 throughout the gaming establishment, each gaming table 68 linked through a network.

It should be appreciated that in a electronic-based implementation, the gaming system would enable the player to place each of the wagers at one time. For example, the player first selects a chip value (such as $1, $5, $25, $100, etc.) if there isn't a default chip value already selected that the player want to play. Then, the player clicks a defined spot. Such a spot could be defined by any of the three bet areas. Alternately, such a spot could be the chip in the chip selection area. For each click, the selected chip amount is added equally to each of the three spots. If the player doesn't have enough money remaining to place the currently selected chip to all three bet areas, then this chip is no longer available.

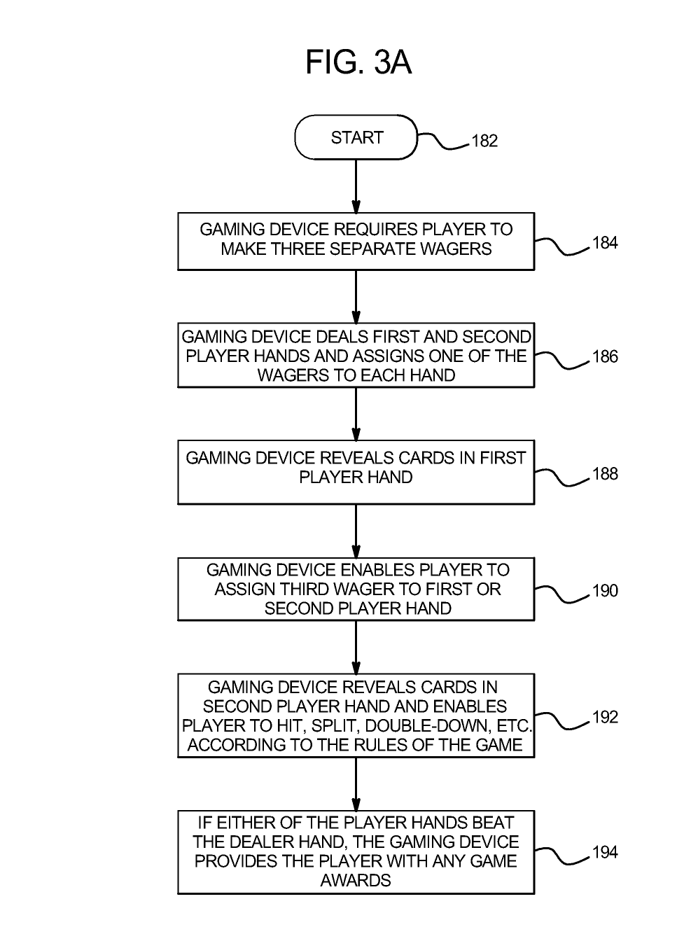

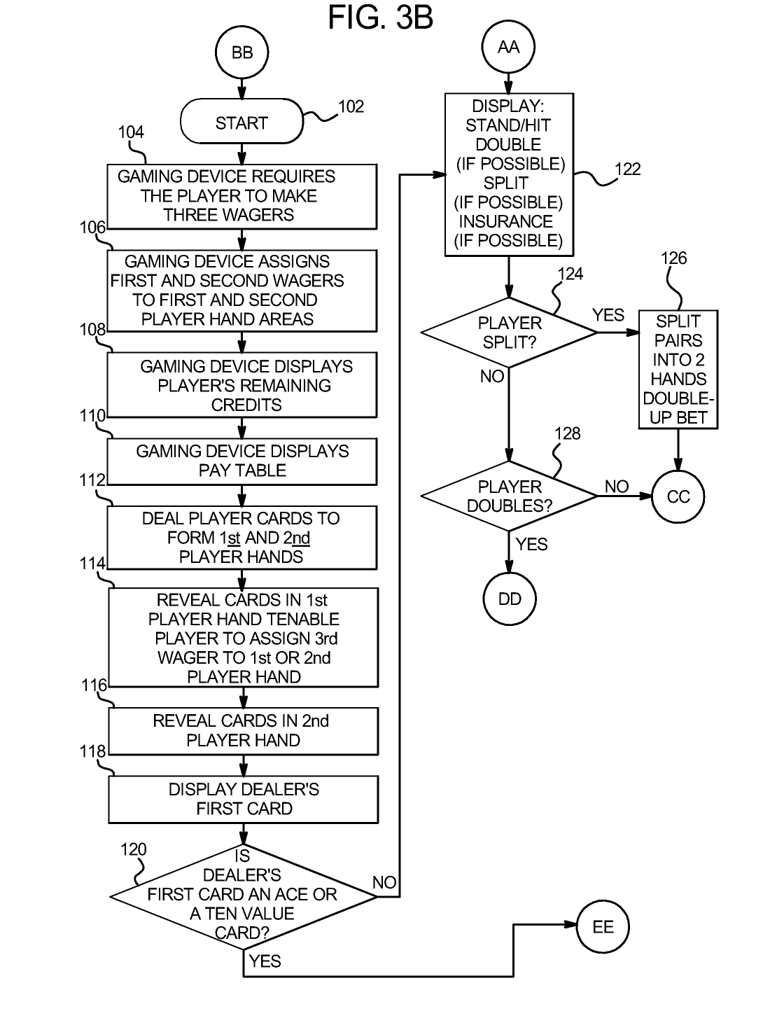

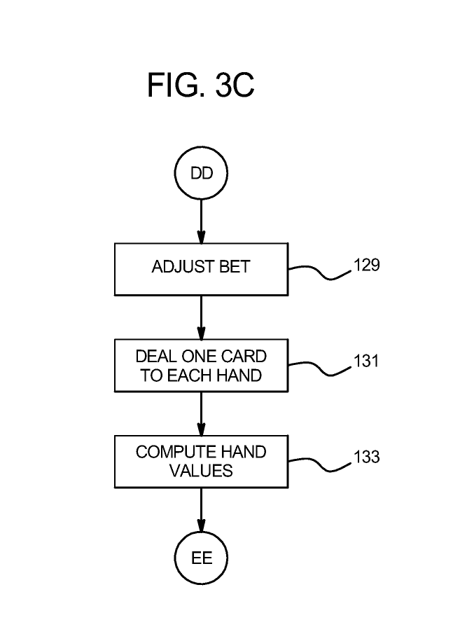

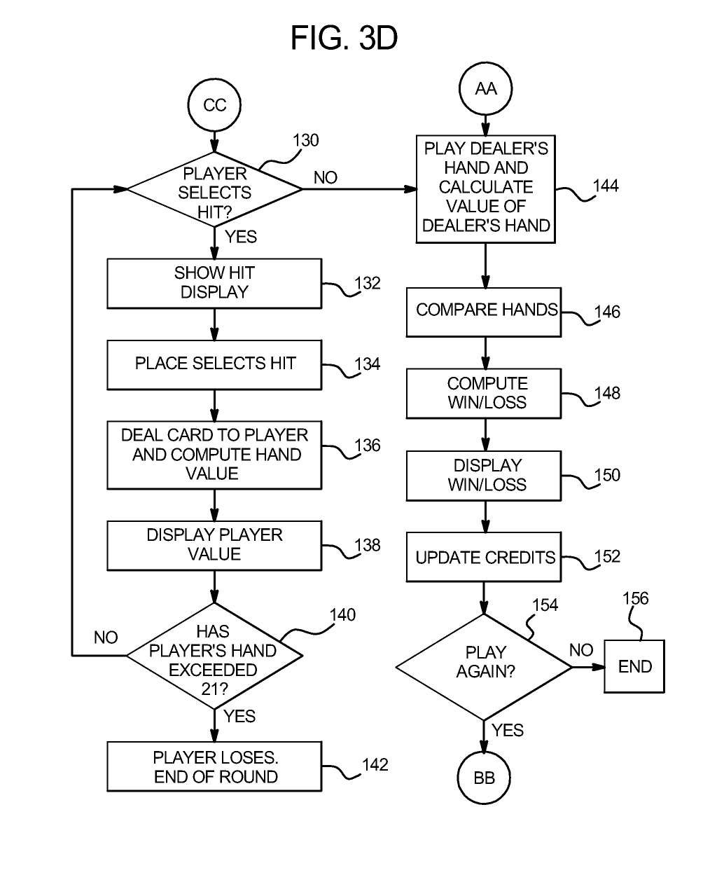

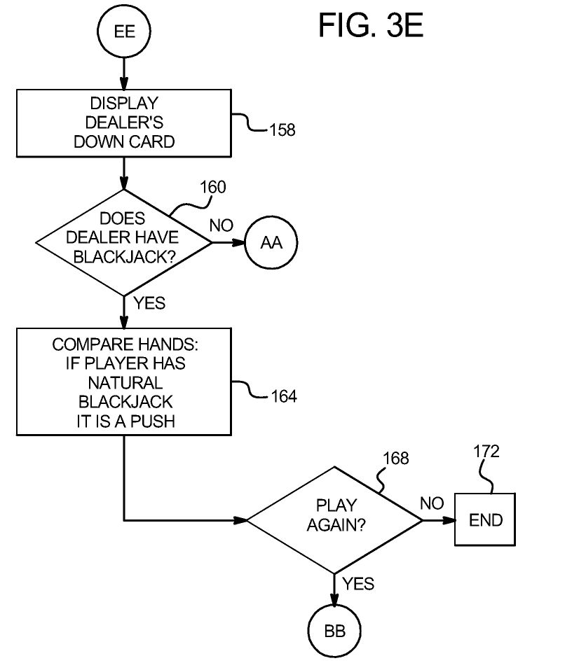

FIGS. 3A to 3E depict the general concept of a player being able to assign a third wager to either a first or second player hand. Although this example is applied to a multiple hand game of Blackjack, it should be appreciated that the general concept of applying an additional wager to one of a plurality of player hands based on incomplete information of the cards in the player hands can be used in conjunction with any suitable multiple hand card game including, but not limited to Three Card Poker or Five Card Poker.

As shown in FIG. 3A, at the start 182 of a round of play of the Blackjack game, the gaming device or gaming system requires the player to place three separate wagers, as indicated in step 184. The gaming device causes first and second player hands to be dealt, and assigns a first one of the wagers to the first player hand and assigns a second one of the wagers to the second player hand, as indicated in step 186. The gaming system then causes the cards in the first player hand to be revealed, as indicated in step 188. At this stage, the cards in the second player hand are not yet revealed. This is somewhat contrary to traditional Blackjack games where either all of the cards (or none of the cards) in the player hands are initially revealed. In alternative embodiments, the first hand could be dealt, the player could then be required to make a decision of whether to place the third wager on the first hand or the second hand, and than the second hand could be dealt. In alternative embodiments, the dealers face-up card may or may not be shown to the player before the player has to make a decision on where to place the third wager.

The gaming system enables the player to assign the third wager to either the first player hand or the second player hand, as indicated in step 190. Accordingly, at this stage in the play of the game, the player must assign the third wager to one of the player hands with incomplete knowledge of all the player cards. That is, the player knows the values of the cards in the first player hand, but does not know the values of the cards in the second player hand. The gaming system then reveals the cards in the second player hand and enables the player to, for each hand, split, double-down, hit or stand according to the rules of the Blackjack game, as indicated in step 192. The gaming system then determines the values of the final player and dealer hands, and provides the player with any awards, as indicated in step 194. Because the player is able to increase their overall wager amount on a good starting hand by assigning the pre-committed wager to this hand, or avoid increasing the wager on a poor starting hand by assigning the pre-committed wager to a different hand, the player has a certain advantage over the gaming establishment relative to standard Blackjack wagering rules.

In various embodiments, the gaming system or method implements certain rule changes to offset the player advantage. In one example, the payout on a Blackjack hand for any of the player hands can be reduced to a 1:1 payout rather than the standard 3:2 payout. In another embodiment, only the Blackjack payout on the hand with the third wager is reduced. In another embodiment, the payout on the third wager is different than for the first and second wager. In another embodiment, if the dealer's final hand value is twenty-two, then the wagers associated with each player hand which is neither a blackjack hand, nor a busted hand is returned to the player. In another embodiment, players lose all ties. In another embodiment, the player loses on certain ties. In another embodiment, one or more standard blackjack rule options are established in the casino's favor including but not limited to dealer hitting a soft-17, limited player split and/or double down opportunities, etc. It should be appreciated that any other suitable method of adjusting the overall house advantage can be used provided that the player does not risk forfeiting the entire pre-committed wager.

In further embodiments, the game includes more than two player hands, such as three, four or more hands. In these embodiments, the number of wagers is greater than the total number of hands and the mathematically expected advantage to the house can be adjusted by adjusting the total number of hands (but not all of the hands) revealed prior to requiring the player to commit each additional wager to one of the hands.

Referring now to FIGS. 3B to 3E, in one embodiment, the game is a multiple hand Blackjack game as described above. A round of play of the game starts as indicated in block 102, and the gaming system requires each player to make three separate wagers, as indicated in block 104. In one embodiment, each of the three wager amounts are required to be the same. In other embodiments, the amounts can be different and there may be requirements that the third wager (i.e., the wager to be assigned after the cards in the first player hand are revealed) is at least as large as the lowest other wager. In another embodiment, the third wager can be larger than either of the other two wagers. These wager amounts are set by an operator or the house rules and may be any suitable amounts. It should be appreciated that the Blackjack game wagers can be equal or different for each subsequent play of the Blackjack game.

The gaming system assigns the first and second wagers to the first player hand and the second player hand, respectively, as indicated in block 106. In an embodiment, the gaming system causes a display of each player's remaining credits or balance, as indicated in block 108. The gaming system may also display the game rules or the pay table (e.g., Blackjack payout ratio) for the Blackjack game, as indicted by block 110.

The gaming system causes two cards to be dealt to each of the player's hands face-down, as indicated by block 112, and also causes two cards to be dealt to form the dealer hand. In one embodiment, one of the two cards in the dealer hand can be dealt face-up. The gaming system reveals the two cards in the first player hand to the player and enables the player to assign the third wager to either the first player hand or the second player hand, as indicated in block 114. After the player has assigned the third wager to one of the player hands, the gaming system causes a display of the value in each of the player hands and the total card value of the up-card in the dealer hand, as indicated in blocks 116 and 118. After all of the wagers have been assigned to the different player hands, the remainder of the play of the Blackjack game proceeds as it does in a standard Blackjack game, and as described in further detail below.

If the dealer's revealed card or face-up card is an Ace or a Ten value card 120, there is a possibility that the dealer has Blackjack, in which case the round of play of the game would end without the player drawing any cards. In this embodiment, an immediate determination of whether the dealer has Blackjack may be required. If the dealer's face-up card is not an Ace or a Ten value card, the Blackjack game can continue. In a different embodiment, each player may hit before the dealer's down-card is revealed. In an embodiment where the game is played at an electronic gaming console or at an automated gaming table, the gaming system activates and displays a stand button, a hit button, a double-down button (if doubling is allowed for that situation under house rules), and the split button (if splitting is allowed for that situation under house rules), as indicated in block 122.

If pairs of the same value cards are dealt in at least one of the players' hands, the split button becomes active and the player can choose to split the pairs as indicated in decision diamond 124. For each applicable player, if the pair of cards is split, the wager is doubled and the player plays out each hand according to normal rules, as shown in block 126. In this embodiment, because the player may have already assigned the third wager to the same hand to which they choose to double-down, the player will effectively have the opportunity to quadruple the amount of the original wager on the original hand. That is, when the player assigns the third wager to this hand, they have effectively doubled the initial wager for that hand. Then, when the player chooses to double-down based on the two cards in this player hand, they are effectively doubling the previously doubled wager. Accordingly, in this embodiment, a player may be more inclined to assign the third wager to the first player hand if the cards in the first player hand present a double-down or splitting opportunity. Under certain house rules, if the split pair is a pair of Aces, the bet is doubled and the player receives only one additional card for each new hand. Moreover, under certain house rules, split pairs may be subsequently re-split or re-doubled a number of times.

Continuing with FIG. 3B, if splitting of the player hands is not an option, or if the player decides not to split the pair, the player must choose whether or not to double-down, if possible, as indicated by decision diamond 128. Also, at this time the player decides whether to take insurance or surrender (not shown) based upon the controlling house rules of Blackjack.

As seen in FIG. 3C, after the player has chosen to double-down, the wager is adjusted as indicated in block 129. In such a case, one and only one card is dealt to the players' respective hand, as indicated in block 131. The gaming system calculates or the dealer determines the value of each hand, as indicated by block 133.

As shown in FIG. 3D, and continued from FIG. 3B, if the player has not chosen to split or double-down, the player may take a hit as indicated in block 130. The gaming system displays the hit button and becomes active as indicated in block 132. The player may take a hit, as indicated by block 134. Then, the gaming system causes a card to be dealt to the player and computes the value of the player's hand, as indicated by block 136. The gaming system displays the value of the player's hand, as indicated by block 138. The gaming system or the dealer determines if the player's hand has exceeded a value of twenty-one, as indicated by decision diamond 140. If a player's hand exceeds twenty-one, the player has busted and loses the wager associated with that particular player hand, as indicated by block 142 and the play of the game for that particular player hand ends, as indicated by step 156. In this embodiment, if the player would have assigned the third wager to this hand, the player would have lost two-thirds of the player's original wagers. If the player has not exceeded twenty-one, the player may hit again, as indicated by decision diamond 130.

Continuing with FIG. 3D, if the player has not exceeded twenty-one, and has chosen to stand, as indicated by block 130, the dealer hand is played out according to traditional Blackjack rules or the controlling house rules, as indicated by block 144. The gaming system compares the value of the dealer hand to the value of each of the remaining players hands, as indicated by block 146, and determines whether each of the remaining player hands have won or lost the round of play of the Blackjack game, as indicated by block 148. The gaming system displays the win or loss information on a display device, as indicated in block 150. If the player has won or pushed, the player credits are updated, as indicated by block 152.

Referring to FIG. 3E, and continuing from FIG. 3B, if the dealer's face-up card is an Ace or a ten-value card, the gaming system must determine whether or not the dealer hand is a Blackjack. The gaming system identifies the down-card in the dealer hand, as indicated by block 158, and determines if the dealer has a Blackjack, as indicated by block 160. If the dealer does not have a Blackjack, the gaming system plays out the dealer hand according to FIG. 3D, and as described above. If the dealer hand does have blackjack, the gaming system compares the hands as indicated by block 164. The player then has the option to play again as indicated by diamond 168 and block 172. Therefore, in these embodiments, although many of the features resemble standard Blackjack play, there are additional strategic wagering considerations and profiting opportunities for the player.

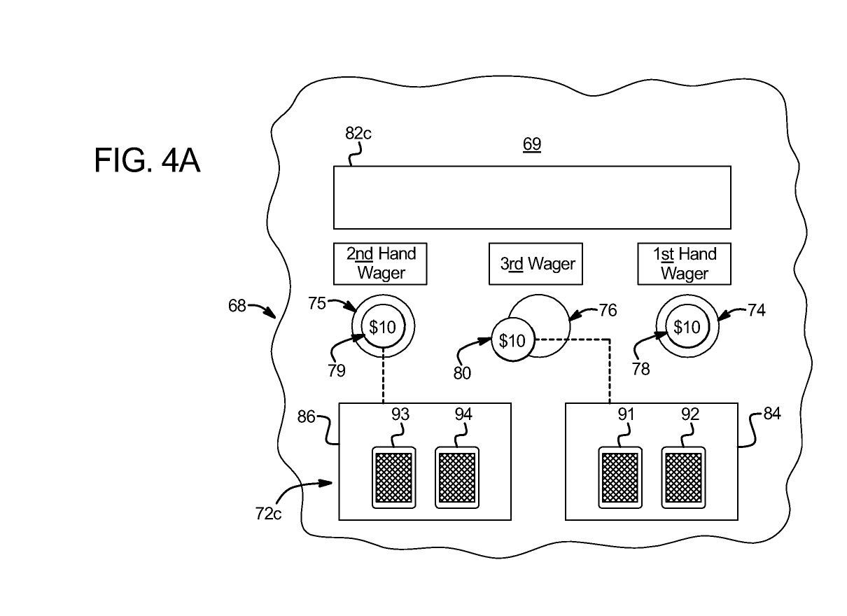

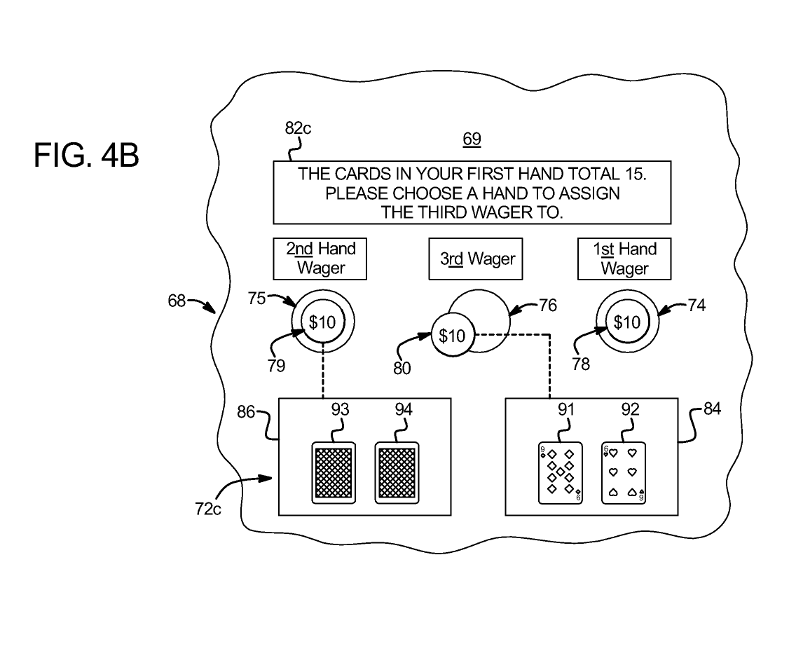

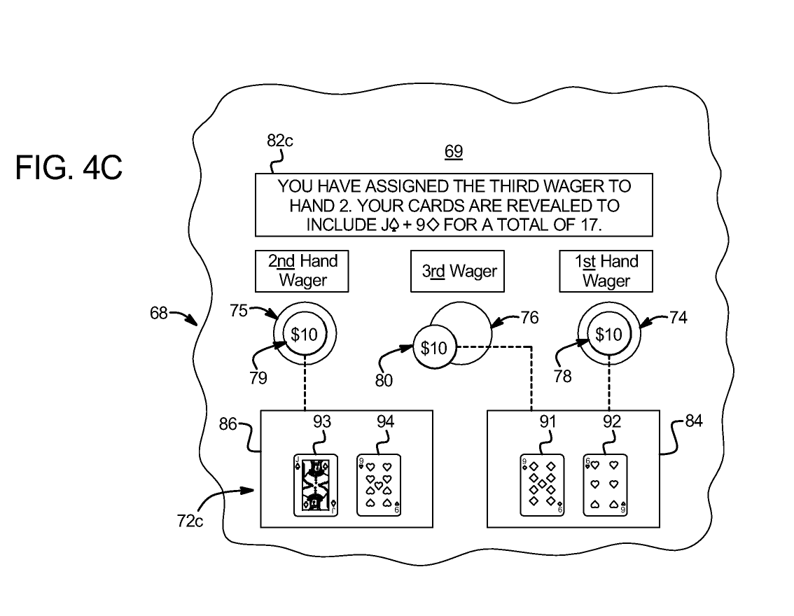

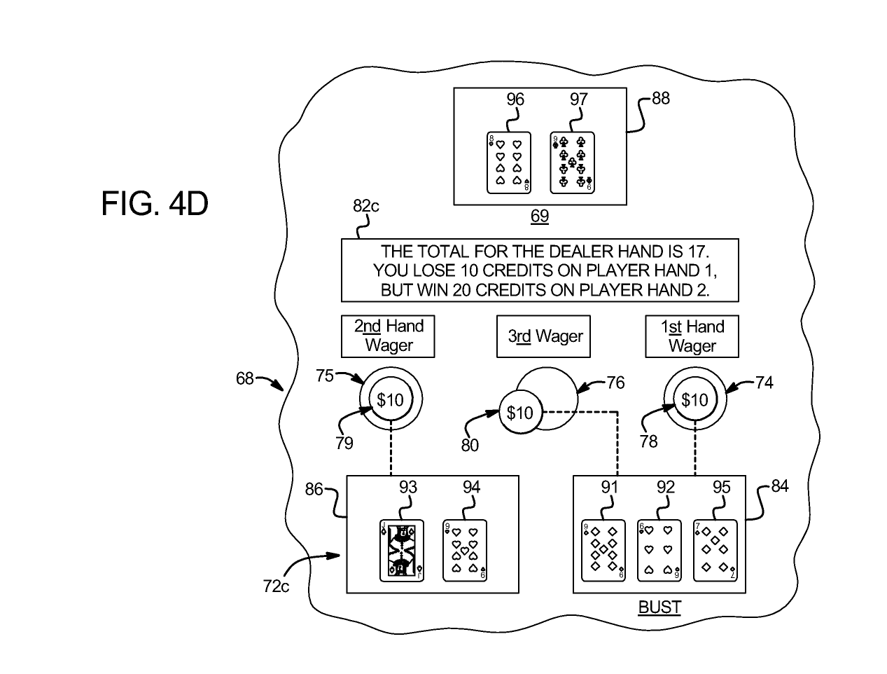

Referring to FIGS. 4A to 4D, an example round of play of a multiple hand Blackjack game is shown. In this embodiment, the Blackjack game is played at a live gaming table 68, on a playing surface 69, with a human dealer, as described above with respect to FIGS. 1C, 1D, and 1E. The gaming table 68 includes a chip tray 70 for holding several stacks of the dealer's chips. The dealer uses chips from the chip tray 70 to pay out winning hands or collect chips from players when they have lost. Although the gaming table 68 includes several different playing areas 72a to 72e for the different players, only the portion of the gaming table 68 including the third playing area 72c is shown in FIGS. 4A to 4D. In this embodiment, there are three wagering areas 74, 75, and 76. In one embodiment, prior to the initiation of the round of Blackjack, each player places the three wagers substantially within their respective game wagering areas 74, 75, and 76. As shown in FIG. 4A, each of the three wagers 78, 79, and 80 each ten credits. However, the wagers may be of any suitable amount. As seen in FIG. 4A, the gaming table 68 includes a display device 82c near the playing area 72c.

The dealer deals two cards 91 and 92 to form a first player hand 84, and deals two cards 93 and 94 to form a second player hand 86. In this embodiment, the cards are all initially dealt face-down. However, it should be appreciated that in other embodiments, the cards in only the first player hand 86 are initially dealt face-up. As shown in FIG. 4A, the first wager 78 located in the first wager area 74 is assigned or associated with the first player hand 84, as indicated by the dashed line connecting the first wager 78 with the first player hand 84. Also, the second wager 79 located in the second wager area 75 is assigned or associated with the second player hand 86, as also indicated by the dashed line connecting the second wager 79 with the second player hand 86. At this point, the third wager 80 located in the third wager area 76 is not assigned or associated with either of the player hands 84 and 86.

Referring to FIG. 4B, the dealer (or the player) reveals the cards in the first player hand 84. In this example, the first card 91 is a 9♦ and the second card 92 is the 6♡. In one embodiment, a suitable card tracking device (not shown) is included in the gaming table 68. The card tracking device identifies the values of each of the player cards 91, 92, 93, and 94 and the gaming system causes these values to be stored in a data storage device (not shown). The gaming system causes the display device 82c to display the total value of the first player hand 84 as fifteen and also prompts the player to assign the third wager 78 to either the first player hand 84 or the second player hand 86, as indicated by display device 82c.

Referring to FIG. 4C, in this example round of play of the game, the player chose to assign the third wager 78 to the second player hand 86, as indicated by the display device 82c and the dashed line connecting the third wager 78 to the second player hand 86. In this example round of play of the game, the total value of the first player hand 84 (i.e., fifteen) is a value that is relatively likely to bust if the player were to take a hit. Therefore, the player decided that it would be disadvantageous to assign the other ten credit wager to this hand. This is true even though the player did not yet know the identity of the cards in the second player hand 86. As shown in FIG. 4C, the dealer (or player) now reveals the cards 93 and 94 in the second player hand 86. In this example round of play of the game, the value of card 93 is the J [symbol] and the value of card 94 is the 9♡ for a total hand value of nineteen, as also indicated in display device 82c.

Referring to FIG. 4D, in this round of play of the game, the player takes a hit card 95 to the first player hand 84. The hit card 95 is a 7♦ such that the total value of the first player hand 84 totals twenty-three, which is a bust hand. The player stands on the second player hand 86. The dealer reveals the second dealer card 97 to be the 9 [symbol] , such that the total value of the dealer hand 88 is seventeen. According to standard Blackjack rules, the dealer must stand on a hard seventeen hand. Accordingly, the first player hand 84 loses on the bust, and the second player hand 86 wins against the dealer hand 88. Therefore, in this particular example play of the game, while the player lost ten credits on the first player hand 84, the player also won twenty credits on the second player hand 86, for a positive net winning amount of ten credits. Accordingly, it was advantageous for the player to not assign the third wager 76 to the first player hand 84, where the first player hand was likely to bust.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of operating a play of a card game, said method comprising:
(a) requiring a player to place three separate wagers including a first wager, a second wager, and a third wager;
(b) initially dealing two separate player hands from a deck of playing cards including a first player hand and a second player hand, the first wager assigned to the first player hand and the second wager assigned to the second player hand;
(c) revealing each of the cards in the first player hand;
(d) before revealing any of the cards in the second player hand, requiring the player to assign the third wager to one of the first player hand and the second player hand;
(e) completing the first player hand and the second player hand in accordance with rules of the card game; and
(f) for each of completed first and second player hands, providing any payouts based on whether the completed player hand is a winning hand and each of the wagers assigned to said competed player hand.

2. The method of claim 1, which includes, after the player assigns the third wager to one of the first player hand and the second player hand, revealing the cards in the second player hand.

3. The method of claim 1, which includes causing each of first and second player hands to initially include two cards.

4. The method of claim 1, which includes dealing a dealer hand from the deck of playing cards, wherein each of the player hands is played against the dealer hand.

5. The method of claim 4, wherein the card game is a Blackjack game.

6. The method of claim 4, which includes revealing one, but not all of the cards, in the dealer hand prior to requiring the player to assign the third wager to either one of the first player hand and the second player hand.

7. The method of claim 4, which includes not revealing any of the cards in the dealer hand prior to requiring the player to assign the third wager to either one of the first player hand and the second player hand.

8. The method of claim 1, which includes requiring the first wager, the second wager, and the third wagers to be equal.

9. The method of claim 1, which is provided through a data network.

10. The method of claim 9, wherein the data network is an internet.

11. A method of operating a play of a card game, said method comprising:
(a) requiring a player to place a designated quantity of separate wagers, said designated quantity of separate wagers being at least three;
(b) initially dealing a designated amount of separate player hands from at least one deck of playing cards, said designated amount being at least two and less than said designated quantity of separate wagers, wherein each player hand is assigned one of said separate wagers;
(c) revealing each of the cards in at least one of the player hands but not all of the player hands;
(d) before revealing any of the cards in at least one of the player hands, requiring the player to assign at least one of the wagers not assigned to any one of the players hand to one of the player hands;
(e) completing each of the player hands in accordance with rules of the card game; and
(f) for each of completed player hands, providing any payouts based on whether the completed player hand is a winning hand and each of the wagers assigned to said competed player hand.

12. The method of claim 11, which includes causing each of player hands to initially include two cards.

13. The method of claim 11, which includes dealing a dealer hand from the at least one deck of playing cards, wherein each of the player hands is played against the dealer hand.

14. The method of claim 13, wherein the card game is a Blackjack game.

15. The method of claim 11, which includes requiring all of the wagers to be equal.

16. The method of claim 11, which is provided through a data network.

17. The method of claim 16, wherein the data network is an internet.

18. A method of operating a play of a card game, said method comprising:
(a) requiring a player to place three separate wagers including a first wager, a second wager, and a third wager;
(b) assigning the first wager to a first player hand and assigning the second wager to a second player hand;
(c) revealing each of the cards in the first player hand;
(d) before revealing any of the cards in the second player hand, requiring the player to assign the third wager to one of the first player hand and the second player hand;
(e) after the player assigns the third wager to one of the first player hand and the second player hand, revealing each of the cards in the second player hand;
(f) completing the first player hand and the second player hand in accordance with rules of the card game; and
(g) for each of completed first and second player hands, providing any payouts based on whether said completed player hand is a winning hand and each of the wagers assigned to said competed player hand.

19. The method of claim 18, which includes causing each of the first and second player hands to initially include two cards.

20. The method of claim 18, which includes dealing a dealer hand from the deck of playing cards, wherein each of the player hands is played against the dealer hand.

21. The method of claim 20, wherein the card game is a Blackjack game.

22. The method of claim 20, which includes revealing one, but not all of the cards, in the dealer hand prior to requiring the player to assign the third wager to either one of the first player hand and the second player hand.

23. The method of claim 18, which includes not revealing any of the cards in the dealer hand prior to requiring the player to assign the third wager to either one of the first player hand and the second player hand.

24. The method of claim 18, which includes requiring the first wager, the second wager, and the third wagers to be equal.

25. The method of claim 18, which is provided through a data network.

26. The method of claim 25, wherein the data network is an internet.

27. A method of operating a play of a card game, said method comprising:
(a) requiring a player to place a designated quantity of separate wagers, said designated quantity of separate wagers being at least three;
(b) for each of a designated amount of separate player hands, said designated amount being at least two and less than said designated quantity of separate wagers, assigning to each of the player hands one of said separate wagers;
(c) revealing each of the cards in at least one of the player hands but less than all of the player hands;
(d) before revealing any of the cards in at least one of the player hands, requiring the player to assign at least one of the wagers not previously assigned to one of the player hands;
(e) after the player assigns all of the wagers, revealing each of the cards in each of the player hands;
(f) completing each of the player hands in accordance with rules of the card game; and
(g) for each of the completed player hands, providing any payouts based on whether the completed player hand is a winning hand and each of the wagers assigned to said competed player hand.

28. The method of claim 27, which includes causing each of player hands to initially include two cards.

29. The method of claim 27, which includes dealing a dealer hand from the at least one deck of playing cards, wherein each of the player hands is played against the dealer hand.

30. The method of claim 29, wherein the card game is a Blackjack game.

31. The method of claim 27, which includes requiring all of the wagers to be equal.

32. The method of claim 27, which is provided through a data network.

33. The method of claim 32, wherein the data network is an internet.
